(19) United States
(12) Patent Application Publication
(10) Pub. No.: US 2012/0011143 A1
(43) Pub. Date: Jan. 12, 2012

(54) Publish and Subscribe Data Delivery System and Method Using Keys

(76) Inventors: David Nash, Conway, AR (US); Kevin Gerald Liles, Maumelle, AR (US); Terry Talley, Conway, AR (US)

(21) Appl. No.: 12/833,756

(22) Filed: Jul. 9, 2010

(51) Int. Cl. G06F 17/30; G06F 15/16

(52) U.S. Cl. 707/769; 707/803; 709/217; 707/827; 707/E17.01; 707/E17.014; 707/E17.032; 707/E17.044

(57) ABSTRACT

A publish and subscribe system and method for ISP data delivery comprises two parts, a subscription part and a data content update part. In the subscription part, a client file is created with records for which data content packages are desired, and the file is sent to the ISP. The ISP creates a file with the requested data and the client integrates this file into its environment. The ISP maintains a record of the requested data. In the data content update part, changes to the relevant data content packages are recognized by the ISP, and an update file is sent to the client. This update file includes only those records that reflect changes since the previous update.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The present invention relates to a system and method for the delivery and update of entity data enhancement products. In particular, the invention is directed to a system and method for the delivery and update of entity data enhancement products pertaining to entities for which available data is commonly enhanced by information service providers; such entities include consumers, businesses, addresses and households.

For purposes of clarity, the following terms to be used herein are defined as follows:

Information service provider (ISP)—An ISP is a company that offers entity data enhancement products for sale.

Client—A client is a business that purchases entity data enhancement products from an ISP.

Consumer—A consumer is a person.

Customer—A customer is a consumer who does business with a client.

Entity—An entity is something to which or someone to whom an ISP's data products pertain. Examples of common ISP entities are consumers, businesses, addresses and households, although the term is not limited by these particular examples.

Entity Key—An entity key (or simply “key”) is a number that uniquely represents a particular entity. The terms “link” and “key” have the same meaning herein and are used interchangeably.

Entity Data Enhancement Products—Entity data enhancement products are data that is known or derived by an ISP about entities, and is offered for sale to clients.

Data Content Packages—Data content packages are defined subsets of the entire set of data that the ISP offers for sale.

Subscriber—A subscriber is a client that has purchased one or more data content packages and requires them to be updated over time.

Publisher—A publisher is an ISP.

Virtually all businesses today find it necessary to keep computerized databases containing information about their customers. Such information can be used in a variety of ways, such as for billing, and for keeping customers informed as to sales and new products. This information is typically stored electronically as a series of records in a computer database, each record pertaining to a particular customer. Records are logical constructs that may be implemented in a computer database in any number of ways well known in the art. The database used may be flat, relational, or may take any one of several other known forms. Each record in the database may contain various fields, such as the customer's first name, last name, street address, city, state, zip code, email address, or telephone number. The records may also contain more complex demographic data, such as the customer's marital status, estimated income, hobbies, or purchase history.

Businesses generally gather customer data from a multitude of sources. These sources may be internal, such as customer purchases, or external, such as the data provided by ISPs to their clients. A number of ISPs maintain large databases of broad-based consumer information that can be sold or leased to their clients. For example, a client that is a catalog-based retail business might wish to know which of its customers are homeowners, as well as such customers' estimated home value, for the purpose of choosing which of its customers should receive a home improvement product catalog mailing. Identifying those customers most likely to purchase products in any particular category will increase the return on investment for the retailer conducting a mailing or other direct marketing campaign, and will reduce the volume of undesired “junk” mail received by the retailer's customers.

Because an ISP's clients use varying methods to collect customer data, they often find themselves with several large but entirely independent databases that contain redundant information about their customers. This problem also commonly occurs when two businesses merge, each business having a legacy database or databases containing customer information. These clients may find it highly desirable to eliminate duplicate data in their databases. They also may wish to accurately link all of the information concerning a particular customer, that is, to “integrate” their data. In addition, they may wish to purchase additional data about their customers, that is, to “enhance” their data. Duplicate elimination and data integration reduces duplicate mailings, which increase the client's costs and may frustrate its customers. Data enhancement may allow the client to more accurately target direct advertising to those customers most likely to be interested in a particular offer or product.

Businesses have historically turned to ISPs for such services as data integration, duplicate elimination services, and data enhancement. The information services industry has devoted enormous resources in recent years to developing various duplicate elimination solutions. These solutions are generally performed after-the-fact, that is, after the instantiation of the duplicate entries within the client's database systems. In many cases, the elimination of duplicates requires more than a simple search for exact matches between name and address fields in two different records. For example, Sue Smith in Memphis and Sue Thompson in Minneapolis may well be the same person, if, for example, such person has moved and changed her last name upon marriage. Even in the case where the name and address are the same, this may not indicate that the records pertain to the same individual, since, for example, the data may pertain to a father and his namesake son. An effective duplicate elimination routine thus may analyze a myriad of data fields, since simply comparing names and addresses will fail to achieve a correct result in many such cases. The fact that many databases contain largely incomplete data makes this problem even more difficult to solve, and in some cases makes a complete solution impossible.

Historically, the procedure by which an ISP integrates and enhances a client's database is through a periodic batch-update cycle. A typical batch update proceeds as follows:
1. the client creates an extract file of its records for which it wants ISP data products;
2. the extract file is sent to the ISP;
3. the ISP converts the file to a standard format for processing, and loads the file into its environment;
4. the ISP does whatever internal processing is necessary to append the requested data products to the client's records, and creates a file containing the client's records and the appended ISP data;
5. the resulting file is sent to the client; and
6. the client integrates the ISP's data from the resulting file into its environment.
   This process is repeated as often as the data needs to be updated. In many cases, ISPs perform the batch-update cycle monthly or semi-monthly for their clients.

The periodic batch-update cycle is a time-consuming and labor-intensive process. A limitation of historical data integration methods is that they provide no means by which a client may remotely and automatically update or enhance the data it maintains for each customer when the data concerning that customer changes. The periodic batch-update cycle may require several weeks from start to finish. The process requires significant direct involvement by the ISP's technical personnel, which is an important factor in the cost of the service.

Another important limitation of the batch approach to data update and enhancement is that all of the client's records must be re-processed by both the ISP and the client at each update cycle, even though only a small percentage of the records likely have different enhancement data than during the previous update cycle. For example, in order to increase the accuracy of its direct mail advertisements, a retailer may desire to update the addresses in its customer database once per month. Most customers will not have changed their address within each one-month period. The periodic batch-update cycle, however, does not tell the retailer which records have had a change. Instead, it just returns the current addresses for each record, so the retailer must process all of its records over again each month to determine those few of its customers who have moved. With databases for large retailers often containing millions of customer records, this is a significant computational burden.

Much of the data that is available to clients from an ISP is data that is associated with entities such as consumers or addresses. An ISP must be able to link a client's records with the ISP's recognized entities in order for the ISP to provide the client with entity-based data products. Thus a linkage is needed from a client's record to the entities in which they are interested. ISPs build various systems to do this, as for example set forth in U.S. Pat. No. 6,523,041, the entire disclosure of which is hereby incorporated by reference. This method provides for an unambiguous data-linking system that generates entity keys for all of the entities known by the ISP. These keys are associated with a client's records. ISPs can then create and store entity-based data products, and provide them to clients based on the entity keys that are associated with the client's records.

Because of the inefficiency and cost of the periodic batch-update cycle, it is desirable to develop a new publish and subscribe data delivery system that is incremental in nature, links records to entities, and addresses all types of data enhancement products provided by the ISP. This goal is achieved, and the limitations of the prior art are overcome, by the present invention as described below.

### BRIEF SUMMARY OF THE INVENTION

The present invention is directed to a publish and subscribe system and method for ISP data delivery. The invention comprises two parts, a subscription part and a data content update part. In the subscription part, a client file is created with records for which data content packages are desired, and the file is sent to the ISP. The ISP creates a file with the requested data and the client integrates this file into its environment. The ISP maintains a record of the requested data. In the data content update part, changes to the relevant data content packages are recognized by the ISP, and an update file is sent to the client. This update file includes only those records that reflect changes since the previous update. In this way, the burden on the client to send new files at each update is relieved, and the burden of updating is greatly reduced by only requiring updates to those files where changes occur.

It may be seen that the present invention results in a number of important advantages over the traditional batch update process. Publishing initial data upon subscription, but then only publishing changes from that point forward, is significantly more computationally efficient than the periodic batch-update model, which requires that all records be re-processed at each update. In addition, the publication of only changes after the initial subscription allows the client to build an incremental update process into its data management applications, whereas today those applications are often inefficient full rebuilds in order to process all of the records that are received in a typical periodic batch-update model. Also, publication of the changes as they occur creates much fresher data for the client than the periodic batch-update cycle; whereas today it is common for clients to send files to ISPs for updates monthly or semi-monthly, using this new approach the data may be updated daily or even continuously in near real time. Finally, publishing the changes as they occur allows a client to treat the changes as events and create business actions based upon them.

In one aspect, the invention is directed to a publish and subscribe data delivery system, comprising an ISP system comprising an entity representation (ER) master storage comprising a plurality of ERs, each ER comprising at least one key, a plurality of data content packages, wherein each of the ERs is linked to at least one data content package by the at least one key of which the ER is comprised, and an ER subscription table comprising a plurality of client records, wherein at least one of the plurality of client records comprises a key of which at least one ER of the plurality of ERs comprising the ER master storage is comprised, at least one subscriber system comprising a plurality of records wherein at least one of such subscriber system records is associated with at least one of the keys of which one of the ERs comprising the ER master storage is comprised, and a communications link between the ISP system and subscriber system whereby files may be transmitted between the ISP system and subscriber system.

In another aspect, the invention is directed to a publish and subscribe data delivery method, the method comprising the steps of building a client file at a subscriber system, wherein the client file comprises a plurality of client records each associated with an entity representation (ER), transmitting the client file from the subscriber system to an ISP system via a communications link between the subscriber system and the ISP system, wherein the ISP system comprises a subscription registration block, a subscription management block, an ER management block, and a client entity representation subscriptions storage comprising an ISP subscription table, associating at least one of the client records in the client file with a unique link corresponding to the ER associated with the client record, updating at the subscription registration block the ISP subscription table to associate the unique link associated with the at least one of the client records to the subscriber system building at the subscription management block an ISP subscription file comprising, for at least one of the client records of the client file, the unique link associated with the ER corresponding to the client record, and at least one of update data and enhancement data, and transmitting the ISP subscription file to the subscriber system via the communications link, receiving at the entity representation management block at least one of update and enhancement data associated with at least one ER, building at the subscription management block an ISP update file comprising, for at least one record of the ISP subscription table the unique link associated with the ER corresponding to the record, and at least one of update data and enhancement data, and transmitting the ISP update file to the subscription system via the communications link.

The features, objects and advantages of the present invention will become better understood from a consideration of the following detailed description of the preferred embodiments and appended claims, in conjunction with the drawings as described following:

### BRIEF DESCRIPTION OF THE SEVERAL VIEWS OF THE DRAWINGS

FIG. 1 is a diagram graphically depicting in overview the subscription portion of a preferred embodiment of the present invention.

FIG. 2 is a diagram graphically depicting in overview the data content update portion of a preferred embodiment of the present invention.

FIG. 3 is a diagram graphically depicting the generation of an entity representation link (ERL) according to a preferred embodiment of the present invention.

FIG. 4 is a diagram graphically depicting the association by an ISP of an ERL with its entity information according to a preferred embodiment of the present invention.

FIG. 5 is a diagram graphically depicting a key linkage hierarchy according to a preferred embodiment of the present invention.

FIG. 6 is a diagram graphically depicting an entity representation (ER) table according to a preferred embodiment of the present invention.

FIG. 7 is a diagram graphically depicting the linkage between an ER table and data content package according to a preferred embodiment of the present invention.

FIG. 8 is a diagram graphically depicting the subscription portion of a preferred embodiment of the present invention, showing greater detail than the diagram of FIG. 1.

FIG. 9 is a diagram graphically depicting the data content update portion of a preferred embodiment of the present invention, showing greater detail than the diagram of FIG. 2.

### DETAILED DESCRIPTION OF THE PREFERRED EMBODIMENT

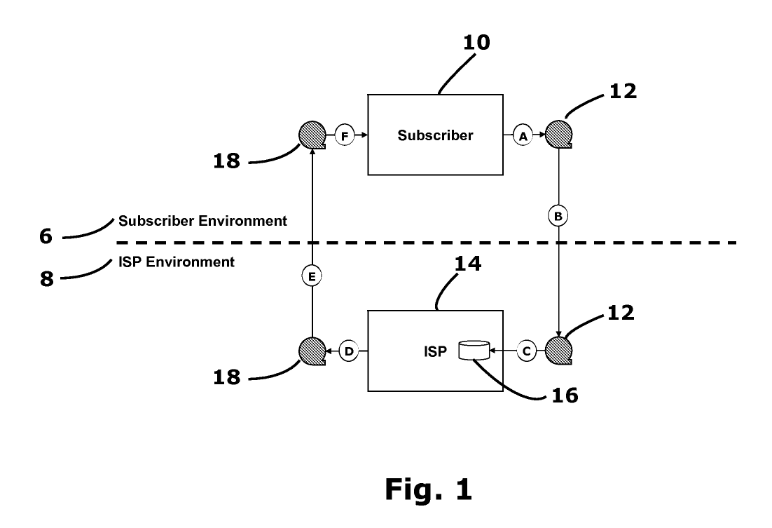

Referring now to FIG. 1, the subscription portion of a preferred embodiment of the present invention may be described in overview. The elements shown in FIG. 1 are divided into the subscriber environment 6 and the ISP environment 8. These two environments may be linked by any means of communications of electronic data as are known in the art, including communication over the Internet or other network, a direct, dedicated telephone line, a microwave link, or they may be connected simply by physically moving media containing the various files to be exchanged at the steps to be described. The subscription portion of FIG. 1 is preferably performed once, at the time when a new client first requests data content packages from an ISP concerning its customers or other entities.

At step A of FIG. 1, the client's subscriber system 10 extracts from its databases a client file 12. Subscriber system 10 may be any sort of computer or computer network capable of storing and processing customer data, as are well known in the art. Client file 12 is preferably an electronic file organized by records, and may be stored in any form of the various forms of electronic storage media as are known in the art. Client file 12 contains records for each entity about which the client desires ISP data content packages. Client file 12 is sent to ISP system 14 at step B. ISP system 14 may be any sort of computer or computer network capable of storing and processing data concerning a large number of entities, as are well known in the art, such systems including mainframe computers, symmetric multiprocess (SMP) servers, and grid-architecture servers. Preferably, ISP system 14 stores information concerning substantially all of the entities within a particular area of interest, such as all consumers or all households in a particular country. ISP system 14 loads information from client file 12 into a subscription table 16 at step C. Subscription table 16 is preferably an electronic file as may be stored in any sort of electronic data storage medium as are known in the art. The purpose of subscription table 16 is to keep track of the entities that are of interest to this particular client. The ISP performs the necessary processing to get the data content packages from its own databases in ISP system 14 for which this particular client has subscribed by means of client file 12. ISP system 14 creates ISP subscription file 18 at step D. ISP subscription file 18 contains such data content packages as correspond to the client's subscription. ISP subscription file 18 is then transmitted at step E to subscriber system 10. Subscriber system 10 is updated with the data in ISP subscription file 18 at step F.

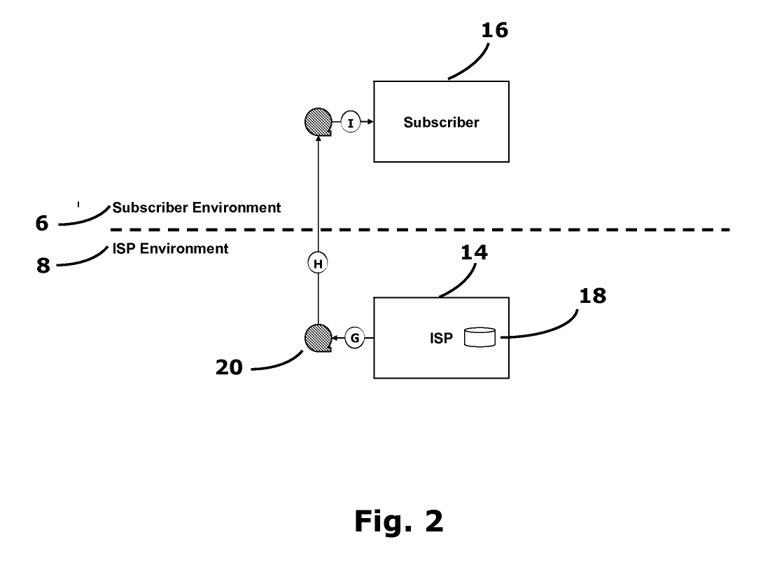

Referring now to FIG. 2, the data content update portion of a preferred embodiment of the present invention may be described in overview. ISP system 14 tracks changes in its data associated with subscription table 16, preferably receiving updates on such data from a myriad of sources. These data updates can occur in any time frame depending upon the data source, from real time to daily, monthly, or less often. Sources for such data may include public entities, such as, for example, the United States Postal Service (USPS), and may also include any number of non-public entities as well. As changes to the data associated with subscription table 16 are recognized, ISP system 14 may create ISP update file 20 at step G. ISP update file 20 contains records that show changes since the last update sent to subscriber system 10. ISP update file 20 is sent to subscriber system 10 at step H, and is integrated with subscriber system 10 at step I. It may be noted since only those records that have received updates are a part of ISP update file 20, the size of ISP update file 20 is likely to be significantly smaller than ISP subscription file 18 sent during the set-up operation of FIG. 1, and thus the integration of records from ISP update file 20 into subscriber system 10 is likely to take significantly less time than the integration of records from ISP subscription file 18 required. Because of the smaller file size, the updates can be performed more often without an undue processing load being placed upon subscriber system 10. In certain embodiments, the updates could be made as each unit of new information is received, so that the updates occur for subscriber system 10 in near real time, assuring the freshest possible data concerning those entities who are customers of the client maintaining subscriber system 10. In order to keep track of which information is changed, ISP system 14 may preferably keep a copy of each version of all of the data products stored at ISP system 14, then compare the updated data that was received to prior versions for each entity. Changes may then be staged to be pushed by means of ISP update file 20 to subscriber system 10 according, in the preferred embodiment, to the parameters established by the subscriber, such parameters including update frequency.

Before proceeding with a more detailed description of the preferred embodiment of the present invention, some concepts that are to be applied in the description of the preferred embodiment must be explained. Entities, as already explained, may be various things, such as people, places, businesses and households. Entity representations (ERs) are ways in which various entities may be represented. For example, the entity John Smith, a natural person, may have any of the various ERs listed below, as well as many other possible ERs:
John Smith, 123 Main St., Conway Ark. 72034
J Smith, 123 Main Street, Conway Ark. 72032
John Smith, (501) 555-4323
John Smith, jsmith@acme.com
   ERs are the primary input to ISP processes according to the preferred embodiment of the invention. The ERs are placed into a consistent, well-defined structure for processing. This is significant, as will be seen, for the purpose of key linkage.

An entity representation link (ERL) is a unique key constructed from the ER associated with that ERL. This key is used for subscription and to publish changes to data associated with the matched ER to clients. It provides a key for managing data and data content that is unique to a particular ER rather than its associated entity keys. As will be seen, the ERL may serve as the root of an entity key tree. Because of the unique association between a particular ERL key and its associated ER, the ERLs can be sent to the ISP in lieu of the actual client record associated with the ERL, which provides a means of communication without the necessity of sending private information over a potentially insecure communications network.

An entity representation table (ER table) is a table that is associated with a particular ERL. The ER table contains the associated entity keys (such as, for example, consumer key, address key, household key, and business key) for a particular ER. The ER table, along with its associated keys, may be used to navigate data content packages.

The entity keys link to data content packages. Since the ERLs link to entity keys, it may be seen then that in this way ERLs are connected to associated data content packages through a two-step association. In other words, the ERL links to its associated keys through the ER table, and the associated keys then provide linkage to associated data content packages. Although enhancement content has traditionally been provided by ISPs to their clients as a flat record, the hierarchy of keys and associated data content packages of the preferred embodiment of the present invention makes it possible to publish content hierarchically at the level of associated entity keys. For example, content could be published at the ERL level, consumer level, household level, or address level for entities that are persons.

It may be seen that with this structure, the preferred embodiment of the present invention is capable of delivering data to a client in many different forms, as desired by the client. Such forms may be submitted in flat files or the standard relational database as often used today. The forms could also include, for example, message queues, and web feed formats such as Really Simple Syndication (RSS) and Atom.

The concepts introduced above may now be described in somewhat greater detail before a more complete and detailed description of the two parts of the preferred embodiment of the present invention is presented. ERs contain the information from a client record that allows an ISP to determine the entity to which the ER pertains. Again, an entity can be things such as a person, a place, a business, or a household, and it may have many possible representations, such as the “John Smith” ER examples given above. The ER contains components that allow an ISP to identify which of its entity keys are associated with that particular ER. For example, an ISP may have associated all of the “John Smith” ERs using the same consumer entity key. In order to ensure consistency, each of the individual components of an ER are preferably required to have formatting and standardization rules. An example of such a formatting rule might be that the strings for name and address must be all ASCII upper case. The well-defined structure would be such that anyone formatting the same components for a particular ER would get the same result. In a preferred embodiment, this may be achieved by the creation of a standard Extensible Markup Language (XML) definition for ERs, such as the following:

```
<ER>
  <Name>JOHN SMITH</Name>
  <Street>123 MAIN ST</Street>
  <CityStZip>CONWAY, AR 72034</CityStZip>
</ER>
```

ERs are the inputs to an ISP's entity identification and enhancement processes. These processes derive the ISP's entity keys as well as any data products that are derived directly from the ER rather than other entity keys.

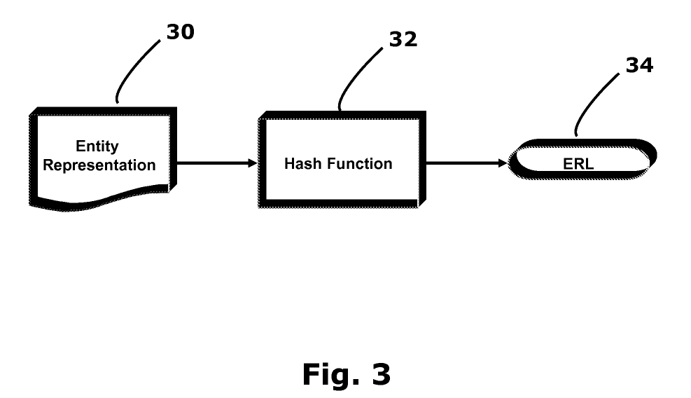

An ERL is preferably implemented as a number that uniquely represents a particular ER. Stated another way, no other ER can have the same number or ERL that any particular ER has within the universe of ERs and ERLs maintained by the ISP. Fundamental to the preferred embodiment of the present invention is the ability to link a client's data to an ISP's data unambiguously. This is achieved by means of a set of unique ERLs. The ERL itself is a number key that is derived by running a hash function on the ER. The hash function will generate a unique non-reversible hash on each unique ER. The uniqueness is ensured by using a hash algorithm that never produces the same hash key for two different inputs. SHA-2 is an example of a family of Secure Hash Algorithm (SHA) hash functions that are well known in the art and that possess this property. FIG. 3 illustrates the ERL creation process. Beginning with a particular ER 30 as input, hash function 32 executes and generates ERL 34 as the output of the function. ERL 34 is a string of bits, such that in the preferred embodiment employing the SHA-2 function, such string would be 256 bits long.

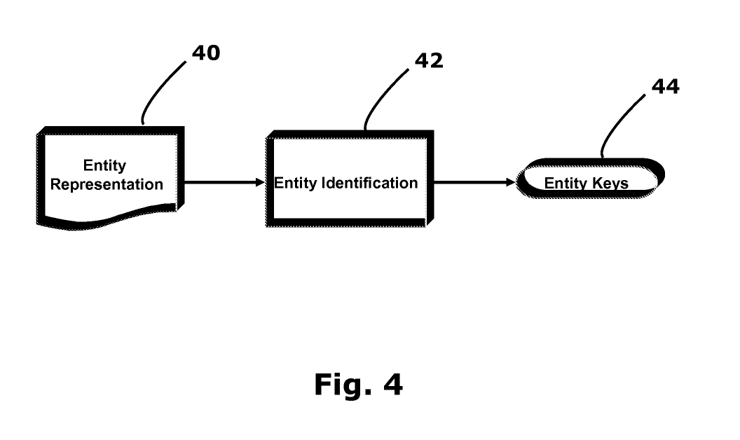

Once the ERL key is generated, This key is returned to the client and becomes the primary subscription key for the linking of client data to ISP data. The ERL is also a key for managing data content packages that are unique to the particular ER, rather than entity keys. (For example, certain postal data may include different deliverability indicators for different address values even though such address values refer to the same entity.) The ISP runs the ER through its process of entity identification and associates its entity keys with that ER and ERL. This process is illustrated in FIG. 4. Beginning with ER 40 as input, the ISP executes its entity identification function 42, the output being those entity keys 44 that are associated with ER 40. This association enables the publishing of data associated with any of those keys to the client.

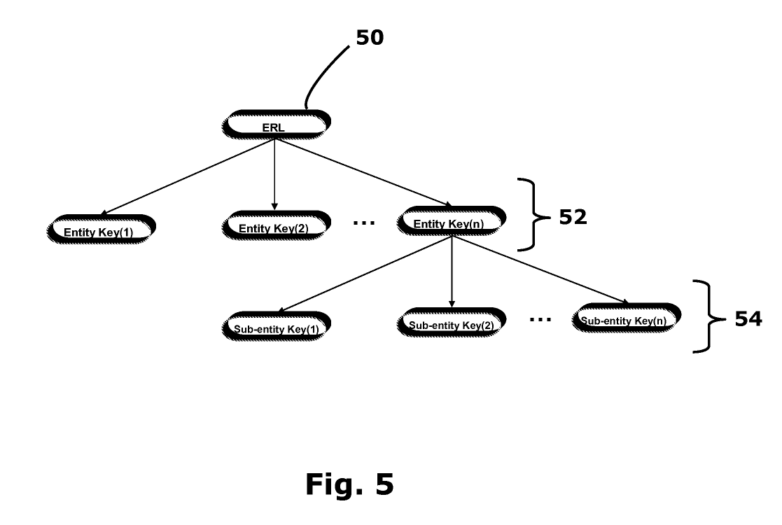

ISP entity keys can also link to other entity keys, as illustrated in FIG. 5. This makes the ERL the root of a tree of linked keys. This tree could be many levels deep in various embodiments of the invention. In FIG. 5, portions of three levels of such a tree are illustrated, with the top level being ERL 50 itself, the second level being entity keys 52 numbered 1 to n, and the third level being those sub-entity keys 54 numbered 1 to n that are associated with entity key 52 numbered n.

It may be seen from the structured described above that the use of ERLs allow clients who do not wish to transmit their ERs to an ISP to be able to receive ISP data without sending the full ER data. Because the ERL construction process is clearly defined and repeatable, a client can construct an ERL for an ER, and only transmit the ERL to the ISP. The ISP can then look up the ERL within its universe of known ERLs, and then in response send enhancement data to the client for that ERL, so long as that ERL is known to the ISP. In this way, only the enhancement data travels over the communications network, and no personally identifying data for the entity associated with the ER may need to be sent either to or from the ISP.

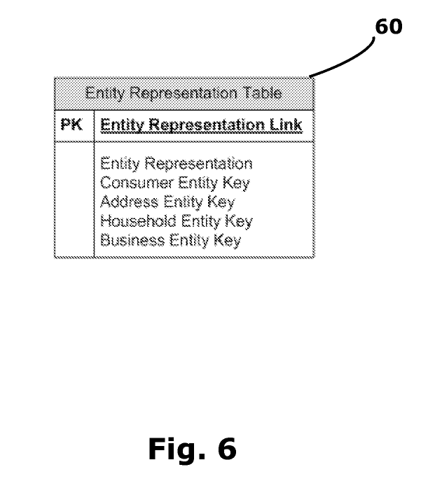

Using these concepts, the structure of an ER table may be discussed as shown in FIG. 6. The ER table 60 for a client contains the ERL as well as a linkage between the ERL and the ISP's associated entity keys. The primary key (PK) on the table is the ERL. The associated entity keys in the example of FIG. 6 are a consumer entity key, an address entity key, a household entity key, and a business entity key. ER table 60 is the basis for navigating to the ISP's data content packages based on keys. In this way, it will be seen that all known information concerning a particular entity is linked together through a particular ER table 60 for that entity.

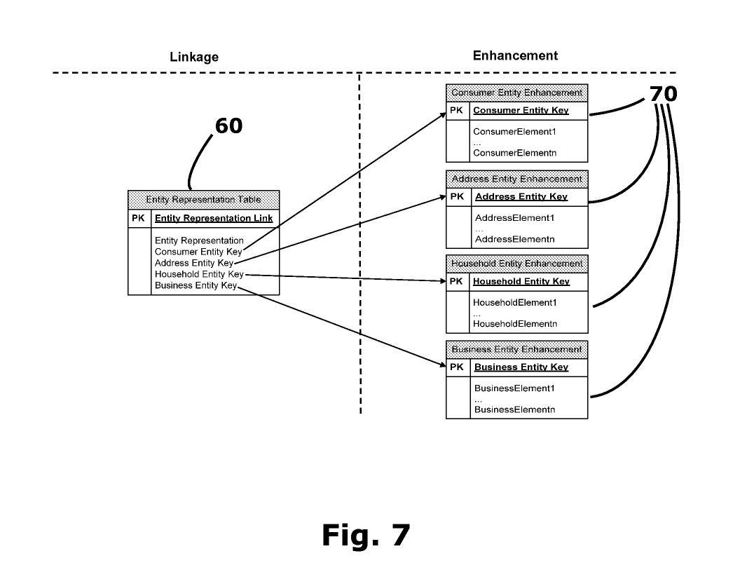

As illustrated in FIG. 7, the associated entity keys of ER table 60 are used to associate ER table 60 with various data content packages 70 associated with each of the associated entity keys. Data content packages 70 contain enhancement data keyed by the ERLs or entity keys. The ERL provides a linkage to an ISP's entity keys via ER table 60. It is now possible to navigate from the ERL to an entity key and then to a data content package 70 keyed on that entity key by means of ER table 60. Data content packages 70 created by the ISP for any of their known entities can now be linked to a client's data through the ERL of ER table 60. It should be noted that while in the example of FIG. 7 only one data content package 70 per associated entity key is shown, there could be many data content packages 70, each of which could be separate tables associated with either an ERL or an associated entity key.

It may be seen from the unique structure of the preferred embodiment of the present invention as described herein that the data content packages are published at the levels of the keys, rather than presented as the industry-standard flat record. This creates a two-dimensional subscription. The first dimension is the universe of ERs to which a particular client subscribes. The second dimension is the set of data content packages for the subscription. If you consider the ISPs complete set of data as a master dataset consisting of many rows (keyed by ERLs or their associated entity keys) and columns (fields in data content packages), then the two-dimensional subscription requires the ISP to be able to filter subscriptions for clients to a subset of both the rows and columns in the ISP's complete set of data.

In addition to handling subscription and update tasks with a client, the ISP must also be capable of handling updates to its own internal data in the form of data changes that are associated with particular entities. ER management is the process of creating and updating entity keys and other ER-level data for this purpose. For example, where the entities of interest are consumers, the entity keys for an ER may change over time as people move, change relationships, or additional information is learned about them. In order to keep the subscribed list of entity keys for a client's ER subscription current, the ERs will need to periodically be processed through the ISP's entity identification process. The preferred embodiment of the present invention provides the opportunity for ISPs to process updates to ERs in a much more efficient way than has been done historically. The historical model has been to process each client file separately, at the time requested by a client. Processing in this way results in ISPs being required to process very high volumes of records through entity identification and entity enhancement. This is a redundant process due to the fact that many clients in fact have the same ERs. The preferred embodiment of the present invention, by contrast, will only internally process each ER once when periodic entity identification is needed, rather than once per subscribed client. ER's that have had changes can then be published to any clients who are subscribed to them. ER management will also be the source for any data content packages that are unique to an ER rather than an entity.

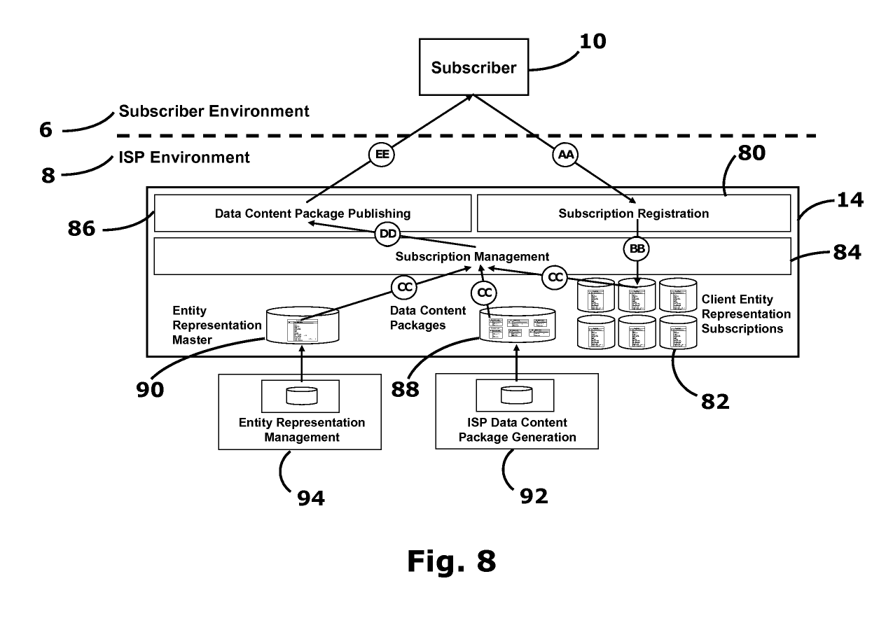

In light of the descriptions of the various elements of the preferred embodiment of the present invention as set forth above, a more detailed description may now be presented of the subscription portion of a preferred embodiment of the present invention, as illustrated in FIG. 8. As previously described with respect to FIG. 1, a subscriber environment 6 includes a subscriber system 10 and an ISP environment 8 includes an ISP system 14. At step AA, the client subscribes to a universe of ERs with the ISP, and subscribes to 1 to n data content packages associated with those ERs. The ERs are received at ISP system 14, and subscription registration block 80 calculates ERLs from the ERs received from the client. At step BB, ISP system 14 updates the client's subscription list stored at client entity representation subscriptions storage 82. Preferably, this information is stored as a two-dimensional array, with ER being one dimension and desired data fields being the other dimension. For each subscriber, an ERL list as well as the list of subscribed data packages may preferably be maintained. Subscriptions management block 84 of ISP system 14 recognizes the new subscriptions and pulls the data content packages associated with the client's ERLs at step CC using client entity representation subscriptions storage 82, data content packages storage 88, and entity representation master storage 90. At step DD, subscription management block 84 passes the data to data content package publishing block 86 to send to the client. Finally, at step EE, data content package publishing block 86 sends the data to the client at subscriber system 10 in subscriber environment 6. The client then integrates the new data into its environment.

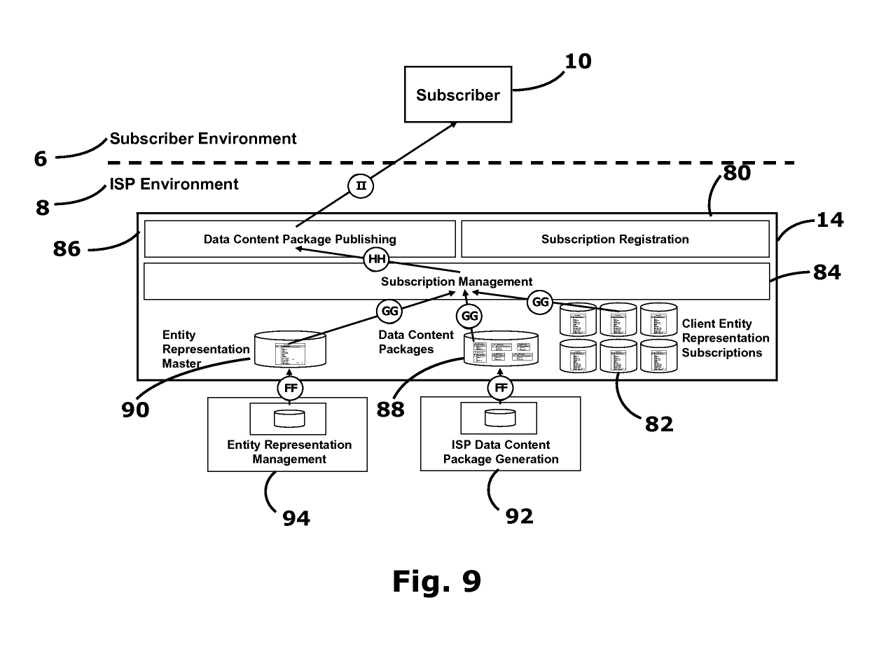

Referring now to FIG. 9, a more detailed description of the data content update portion of a preferred embodiment of the present invention may be described. The update process depends upon the receipt of an update or change to existing data related to an entity. At step FF, entity representation management block 94 and/or ISP data content package generation block 92 produces a data change based on an input of changed data to subscriber system 14 in ISP environment 8. Subscription management block 84 recognizes that a data change has occurred, and determines which clients are subscribed to the keys associated with the data change at step GG. Subscription management block 84 draws upon information stored at entity representation master storage 90, data content packages storage 88, and/or client entity representation subscriptions storage 82 for this purpose. Subscription management block 84 then passes the data changes to data content package publishing block 86, along with a list of the subscribed clients for whom an update is required based upon each client's subscription information, at step HH. Finally, data content package publishing block 86 sends the data to subscriber system 10 in subscriber environment 6 at step II. The client then integrates the new data into its environment. In an update schedule other than real-time update is desired, then the subscriber-specific changes may be queued, and the queue pushed to the subscribers according to the desired schedule, such as, for example, daily, weekly, or on-demand.

It may be seen that this method of subscribing to ERs and receiving data for them based on associated entity keys and data package subscriptions allows an ISP to easily introduce new data products to the environment. If an ISP creates a new kind of entity key and associated data for it, it is easily added to an already available framework. Similarly, this method could easily be extended to allow the ISP to broker data for a third party. The ER management process could be extended to provide a third party entity key or keys, then the third party would only need to provide data content packages keyed on their entity keys.

The relational nature of the linkage to data through keys makes it possible to create a standard relational data model to store an ISP's data content packages. The creation and automatic updating of a standard relational database model is one example of how this system could be implemented on the client side, which would vastly simplify the work that is required in the periodic batch update cycle. Other examples would be to publish flat files, publish to a message queue, or use other publishing tools like RSS or Atom.

As used herein, “comprising” is synonymous with “including,” “containing,” or “characterized by,” and is inclusive or open-ended and does not exclude additional, unrecited elements or method steps. As used herein, “consisting of” excludes any element, step, or ingredients not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements. The invention illustratively described herein suitably may be practiced in the absence of any element or elements, limitation or limitations which is not specifically disclosed herein.

When a Markush group or other grouping is used herein, all individual members of the group and all combinations and subcombinations possible of the group are intended to be individually included in the disclosure.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims. Thus, additional embodiments are within the scope of the invention and within the following claims.

Unless specified otherwise, the general the terms and phrases used herein have their art-recognized meaning, which can be found by reference to standard texts, journal references and contexts known to those skilled in the art. The preceding definitions are provided to clarify their specific use in the context of the invention.

All patents and publications mentioned in the specification are indicative of the levels of skill of those skilled in the art to which the invention pertains. All references cited herein are hereby incorporated by reference to the extent that there is no inconsistency with the disclosure of this specification.

The present invention has been described with reference to certain preferred and alternative embodiments that are intended to be exemplary only and not limiting to the full scope of the present invention as set forth in the appended claims.

What is claimed is:

1. A publish and subscribe data delivery system, comprising:
(a) an ISP system comprising:
(i) an entity representation (ER) master storage comprising a plurality of ERs, each ER comprising at least one key;
(ii) a plurality of data content packages, wherein each of the ERs is linked to at least one data content package by the at least one key of which the ER is comprised; and
(iii) an ER subscription table comprising a plurality of client records, wherein at least one of the plurality of client records comprises a key of which at least one ER of the plurality of ERs comprising the ER master storage is also comprised;
(b) at least one subscriber system comprising a plurality of records wherein at least one of such subscriber system records is associated with at least one of the keys of which one of the ERs comprising the ER master storage is also comprised; and
(c) a communications link between the ISP system and subscriber system whereby files may be transmitted between the ISP system and subscriber system.

2. The publish and subscribe data delivery system of claim 1, wherein the at least one subscriber system is configured to create a client file comprising a plurality of client records and transmit the client file to the ISP system via the communications link.

3. The publish and subscribe data delivery system of claim 2, wherein the ISP system further comprises a subscription registration block configured to receive the client file sent by the subscriber system via the communications link and to update the ER subscription table using the client records in the client file.

4. The publish and subscribe data delivery system of claim 3, wherein the ISP system further comprises a subscription management block configured to create an ISP subscription file comprising updated client records and transmit the ISP subscription file to the subscriber system via the communications link.

5. The publish and subscribe data delivery system of claim 4, wherein at least one of the client records of the ISP subscription file comprises a key corresponding to an entity associated with such at least one client record.

6. The publish and subscribe data delivery system of claim 5, wherein the subscription management block is further configured to create an ISP update file comprising updated client records and transmit the ISP update file to the subscriber system via the communications link.

7. The publish and subscribe data delivery system of claim 6, further comprising an entity representation management block configured to receive updated data concerning ERs and to at least one of update and enhance the ERs of which the ER master storage is comprised.

8. The publish and subscribe data delivery system of claim 7, wherein the ER subscription table comprises a two-dimensional array for each of the at least one subscriber system, wherein a first dimension of the two-dimensional array is at least one ER and a second dimension of the two-dimensional array is at least one data field.

9. The publish and subscribe data delivery system of claim 1, wherein each of the plurality of ERs comprises an ER link and at least one other entity key.

10. The publish and subscribe data delivery system of claim 9, wherein the at least one other entity key of which each of the plurality of ERs is chosen from the set of keys consisting of a consumer entity key, an address entity key, a household entity key, and a business entity key.

11. The publish and subscribe data delivery system of claim 10, wherein the at least one other entity key of which each of the plurality of ERs is comprised is shared by at least one data content package.

12. The publish and subscribe data delivery system of claim 11, wherein each of the plurality of ERs comprises a plurality of other entity keys, and each of the plurality of other entity keys is shared by at least one data content package.

13. A publish and subscribe data delivery method, the method comprising the steps of:
(a) building a client file at a subscriber system, wherein the client file comprises a plurality of client records each associated with an entity representation (ER);
(b) transmitting the client file from the subscriber system to an ISP system via a communications link between the subscriber system and the ISP system, wherein the ISP system comprises a subscription registration block, a subscription management block, an ER management block, and a client entity representation subscriptions storage comprising an ISP subscription table;
(c) associating at least one of the client records in the client file with a link corresponding to the ER associated with the client record;
(d) updating at the subscription registration block the ISP subscription table to include data from the client file;
(e) building at the subscription management block an ISP subscription file comprising, for at least one of the ERs of the client file:
(i) the key associated with the ER; and
(ii) data associated with the ER;
and transmitting the ISP subscription file to the subscriber system via the communications link;
(f) receiving at the entity representation management block at least one of update and enhancement data associated with at least one ER;
(g) building at the subscription management block an ISP update file comprising, for at least one ER:
(i) the key associated with the ER; and
(ii) at least one of update data and enhancement data associated with the ER;
and transmitting the ISP update file to the subscription system via the communications link.

14. The publish and subscribe data and delivery method of claim 13, wherein the ISP system further comprises ER master storage comprising a plurality of ERs, and wherein the step of building the ISP subscription file further comprises the step of matching an ER stored at the ER master storage with a client record.

15. The publish and subscribe data and delivery method of claim 14, wherein the step of matching an ER stored at the ER master storage with a client record during the building the ISP subscription file step comprises the step of searching for a match between a key stored at the ER and a key stored in the client record.

16. The publish and subscribe data and delivery method of claim 15, wherein the ISP system further comprises data content packages storage comprising a plurality of data content packages, each comprising a key and data associated with an ER corresponding to the key, and wherein the step of building the ISP subscription file further comprises the step of matching the key stored at the ER with the same key stored at one of the data content packages.

17. The publish and subscribe data and delivery method of claim 16, wherein the step of building the ISP subscription file further comprises the step of matching each of a plurality of other entity keys stored at the ER to the same key stored at one of the data content packages.

18. The publish and subscribe data and delivery method of claim 17, wherein the step of building the ISP update file further comprises the step of matching an ER stored at the ER master storage with a client record from the client ER subscriptions storage.

19. The publish and subscribe data and delivery method of claim 18, wherein the step of matching an ER stored at the ER master storage with a client record from the client ER subscriptions storage during the step of building the ISP update file comprises the step of searching for a match between a key stored at the ER and a key stored in the client record.

20. The publish and subscribe data and delivery method of claim 19, wherein the step of building the ISP update file further comprises the step of matching the key stored at the ER with the same key stored at one of the data content packages.

21. The publish and subscribe data and delivery method of claim 20, wherein the step of building the ISP update file further comprises the step of matching each of a plurality of keys stored at the ER to the same key stored at one of the data content packages.

22. The publish and subscribe data delivery method of claim 16, wherein each of the plurality of ERs at the ER management storage comprises an ER link and at least one other entity key, and the steps of building the ISP subscription file and building the ISP update file each comprise the step of reading data from a data content package with a key matching the other entity key.

23. The publish and subscribe data delivery system of claim 22, wherein each of the plurality of ERs at the ER management storage comprises a plurality of other entity keys, and the steps of building the ISP subscription file and building the ISP update file each comprise the step of reading data from each of the data content packages comprising a key matching one of the other entity keys.
